(19) United States
(12) Patent Application Publication
(10) Pub. No.: US 2025/0371715 A1
(43) Pub. Date: Dec. 4, 2025

(54) METHOD OF MOTION TRACKING AND MOTION TRACKING DEVICE

(71) Applicant: HTC Corporation, Taoyuan City (TW)

(72) Inventor: Chien-Min Su, Taoyuan City (TW)

(73) Assignee: HTC Corporation, Taoyuan City (TW)

(21) Appl. No.: 19/174,910

(22) Filed: Apr. 9, 2025

Related U.S. Application Data
(60) Provisional application No. 63/652,661, filed on May 28, 2024.

(51) Int. Cl. G06T 7/20; G06T 7/579

(52) U.S. Cl. CPC G06T 7/20; G06T 7/579

(57) ABSTRACT

A method of motion tracking and a motion tracking device are provided. The method includes: obtaining a first command; in response to the first command, detecting a first height via an inertial measurement unit to determine a first boundary; capturing a first map via a camera to establish a first coverage of the first map and determining whether the first coverage is complete according to the first boundary; and in response to the first coverage being complete, performing motion tracking according to the first map.

### CROSS-REFERENCE TO RELATED APPLICATION

This application claims the priority benefit of U.S. provisional application Ser. No. 63/652,661, filed on May 28, 2024. The entirety of the above-mentioned patent application is hereby incorporated by reference herein and made a part of this specification.

### BACKGROUND

### Technical Field

The disclosure is related to motion capturing technology, and particularly related to a method of motion tracking and a motion tracking device.

### Description of Related Art

Motion capturing systems are widely used in various industries, including extended reality (XR) and 3D filmmaking. However, accurately capturing human motion remains a challenge due to its complexity. Different limbs can move independently, and tracking one movement may be affected by the motion of another limb, leading to potential inaccuracies. Additionally, the system's performance is influenced by the number of feature points being processed. If there are too many feature points, the computational load increases, potentially causing delays in generating motion capture results. These challenges highlight the need for efficient motion tracking solutions to balance accuracy and real-time performance.

### SUMMARY

The disclosure is directed to a method of motion tracking and a motion tracking device.

The present invention is directed to a motion tracking device including a camera, an inertial measurement unit, an input device, and a processor. The processor is coupled to the camera, the inertial measurement unit, and the input device, wherein the processor is configured to: obtain a first command via the input device; in response to the first command, detect a first height via the inertial measurement unit to determine a first boundary; capture a first map via the camera to establish a first coverage of the first map and determine whether the first coverage is complete according to the first boundary; and in response to the first coverage being complete, perform motion tracking according to the first map.

In one embodiment of the present invention, the processor is further configured to: capture a second map via the camera, wherein a second coverage of the second map is different from the first coverage; and performing the motion tracking according to the first map and the second map.

In one embodiment of the present invention, the processor is further configured to: determining a second boundary based on the first boundary, wherein the first coverage and the second coverage are separated by the second boundary.

In one embodiment of the present invention, the motion tracking device further includes an output device coupled to the processor, wherein the processor is further configured to: detect a second height via the inertial measurement unit and determine whether the second height exceeds the second boundary while the first map is being captured; and in response to the second height exceeding the second boundary while the first map is being captured, output an alarm message via the output device.

In one embodiment of the present invention, the processor is further configured to: obtain a second command via the input device; in response to the second command, detect a third height via the inertial measurement unit to determine a third boundary; and determine whether the second coverage is complete according to the third boundary.

In one embodiment of the present invention, the processor is further configured to: obtain a third command via the input device; and in response to the third command, capture the first map via the camera.

In one embodiment of the present invention, the motion tracking device further includes an output device coupled to the processor, wherein the processor is further configured to: output an instruction message via the output device; and in response to outputting the instruction message, capture the first map via the camera.

In one embodiment of the present invention, the first coverage is restricted by the first boundary.

In one embodiment of the present invention, the processor is further configured to: perform simultaneous localization and mapping to generate a key frame; determine whether a position of the key frame exceeds the first boundary; in response to the key frame not exceeding the first boundary, select the key frame; and determine whether the first coverage is complete according to the selected key frame.

In one embodiment of the present invention, the motion tracking device includes a wearable electronic device.

The present invention is directed to a method of motion tracking, including: obtaining a first command; in response to the first command, detecting a first height via an inertial measurement unit to determine a first boundary; capturing a first map via a camera to establish a first coverage of the first map and determining whether the first coverage is complete according to the first boundary; and in response to the first coverage being complete, performing motion tracking according to the first map.

In one embodiment of the present invention, the step of performing the motion tracking according to the first map including: capturing a second map via the camera, wherein a second coverage of the second map is different from the first coverage; and performing the motion tracking according to the first map and the second map.

In one embodiment of the present invention, the method further includes: determining a second boundary based on the first boundary, wherein the first coverage and the second coverage are separated by the second boundary.

In one embodiment of the present invention, the method further includes: detecting a second height via the inertial measurement unit and determining whether the second height exceeds the second boundary while the first map is being captured; and in response to the second height exceeding the second boundary while the first map is been captured, outputting an alarm message.

In one embodiment of the present invention, the method further includes: obtaining a second command; in response to the second command, detecting a third height via the inertial measurement unit to determine a third boundary; and determining whether the second coverage is complete according to the third boundary.

In one embodiment of the present invention, the step of capturing the first map via the camera including: obtain a third command; and in response to the third command, capturing the first map via the camera.

In one embodiment of the present invention, the step of capturing the first map via the camera including: output an instruction message; and in response to outputting the instruction message, capturing the first map via the camera.

In one embodiment of the present invention, the first coverage is restricted by the first boundary.

In one embodiment of the present invention, the step of determining whether the first coverage is complete according to the first boundary including: performing simultaneous localization and mapping to generate a key frame; determining whether a position of the key frame exceeds the first boundary; in response to the key frame not exceeding the first boundary, selecting the key frame; and determining whether the first coverage is complete according to the selected key frame.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 illustrates a schematic diagram of motion tracking device according to one embodiment of the present invention.

FIG. 2 illustrates a flowchart of motion tracking according to one embodiment of the present invention.

FIG. 3 illustrates a schematic diagram of map scanning according to one embodiment of the present invention.

FIG. 4 illustrates a flowchart of map scanning according to one embodiment of the present invention.

FIG. 5 illustrates a flowchart of a method of motion tracking according to one embodiment of the present invention.

### DESCRIPTION OF THE EMBODIMENTS

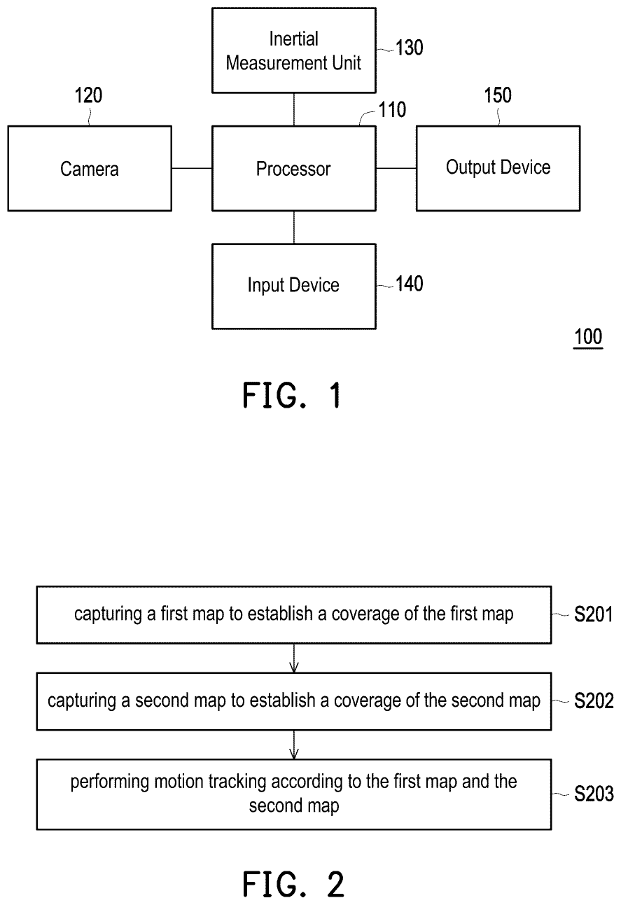

FIG. 1 illustrates a schematic diagram of motion tracking device 100 according to one embodiment of the present invention. The motion tracking device 100 can be a wearable electronic device. For example, the motion tracking device 100 can be worn on the chest or a limb of a user. The motion tracking device 100 may establish one or more maps (e.g., virtual map or point cloud) for motion tracking. For example, a map generated by the motion tracking device 100 may include feature points related to environmental obstacles. During the motion tracking, these feature points may be ignored as they are not related to user's motions.

The motion tracking device 100 may include a processor 110, one or more cameras 120, an inertial measurement unit (IMU) 130, an input device 140, and an output device 150. The processor 110 may be, for example, a central processing unit (CPU), or other programmable general purpose or special purpose micro control unit (MCU), a microprocessor, a digital signal processor (DSP), a programmable controller, an application specific integrated circuit (ASIC), a graphics unit (GPU), an arithmetic logic unit (ALU), a complex programmable logic device (CPLD), a field programmable gate array (FPGA), or other similar device or a combination of the above devices. The processor 110 may be coupled to the camera 120, the IMU 130, the input device 140, and the output device 150.

The camera 120 may be a photographic device for capturing images. The camera 120 may include a complementary metal oxide semiconductor (CMOS) sensor or a charge-coupled device (CCD) sensor. The processor 110 may perform map scanning by using the camera 120.

The IMU 130 can be used to measure acceleration to obtain the posture of the user wearing the motion tracking device 100 or the location (e.g., the height) of the motion tracking device 100.

The processor 110 may receive user commands via the input device 140. The input device 140 may include but not limited to a button or a touch screen.

The processor 110 may notify messages to the user wearing the motion tracking device 100 via the output device 150. The output device may include but not limited to a display or a speaker.

The motion tracking device 100 may be worn on the chest of a user. When scanning a map, the user may stand up and operate the input device 140 (e.g., press the button). The motion tracking device 100 may record the height measured by the IMU 130 accordingly. The motion tracking device 100 may subtract the recorded height from a default value (e.g., 40 cm) to obtain the height of the map center, wherein the map center may be used to distinguish different areas to be scanned. However, due to the heights or the postures of different users may be different, the manner mentioned above may not be ideal. When a user is too short or too tall, it will cause uneven distribution in the different areas to be scanned, and the quality of the generated map could be poor. Therefore, an improved approach must be submitted.

FIG. 2 illustrates a flowchart of motion tracking according to one embodiment of the present invention, wherein the flowchart can be implemented by the motion tracking device 100 as shown in FIG. 1. In step S201, the processor 110 may capture a first map via the camera 120 to establish a coverage of the first map. The first map may be, for example, a map corresponding to a upper area (e.g., the area above the user's waist) or a lower area (e.g., the area below the user's waist). The processor 110 may determine one or more boundaries to restrict the coverage of the first map. The processor 110 may determine whether the coverage of the first map is completed according to the one or more boundaries.

Specifically, the processor 110 may capture the first map by performing simultaneous localization and mapping (SLAM) algorithm to generate one or more key frames, wherein the position of each key frame may be measured through the IMU 130. For each key frame, the processor 110 may determine whether the position of the key frame exceeds the boundary. If the key frame not exceeds the boundary, the processor 110 may determine the key frame is valid and may select the key frame. If the key frame exceeds the boundary, the processor 110 may determine that the key frame is invalid and may ignore the key frame. The processor 110 may determine whether the coverage of the first map is completely established according to the selected key frames. For example, the processor 110 may determine the coverage of the first map is completely established if the number of the selected key frames is greater than a threshold.

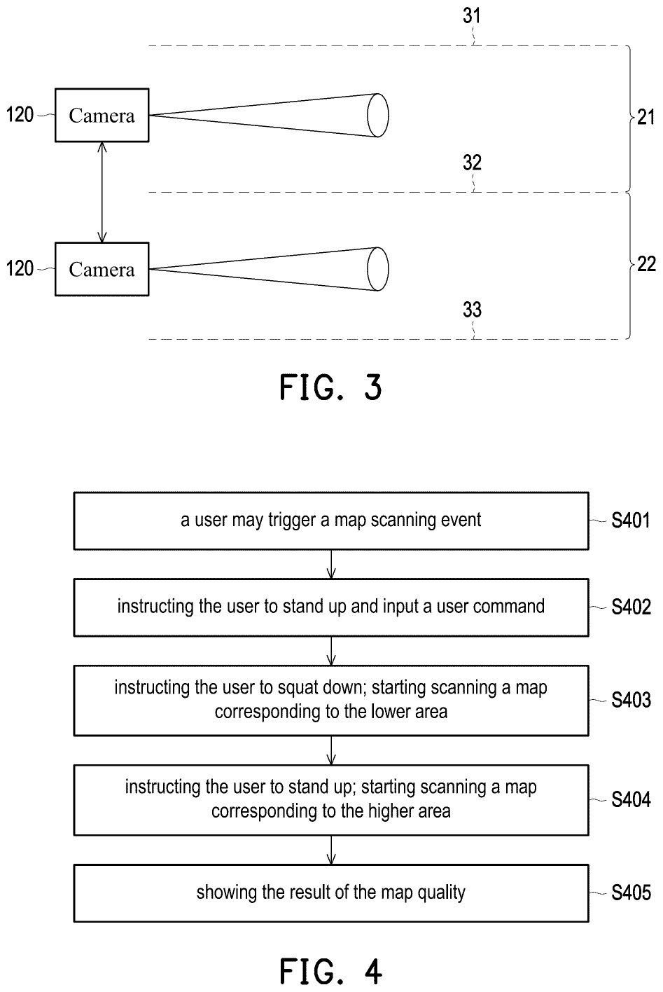

Take FIG. 3 as example, assume that the first map corresponds to area 21. Boundary 31 may be the upper boundary of the first map and boundary 32 may be the lower boundary of the first map. The processor 110 may perform SLAM algorithm to establish the coverage of the first map by scanning the area 21 via the camera 120. If a key frame captured by the camera 120 is beyond or equal to boundary 32 and/or below or equal to boundary 31, the processor 110 may determine that the key frame is valid and may determine whether the coverage of the first map is completely established according to the valid key frame. Otherwise, if a key frame captured by the camera 120 is beyond boundary 31 or below boundary 32, the processor 110 may determine that the key frame is invalid. The completeness of the coverage of the first map will not be affected by invalid key frames.

In one embodiment, the processor 110 may detect the height of the motion tracking device 100 via the IMU 130 and determine whether the height exceeds the boundary while the first map is being captured. If the height of the motion tracking device 100 exceeds the boundary while the first map is being captured, the processor 110 may output an alarm message via the output device 150. For example, the processor 110 may output an instruction message to the user to instruct the user to assume a specific posture (e.g., stand up) for scanning the first map corresponding to area 21. The instruction message may specify a start time point and the processor 110 may start capturing the first map via the camera 120 at the start time point. Alternatively, the processor 110 may start capturing the first map via the camera 120 after receiving a user command via the input device 140. If the height of the motion tracking device 100 falls below boundary 32 (or rise beyond boundary 31) while the coverage of the first map is being scanned in area 21, the processor 110 may output the alarm message to the user to instruct the user to change his posture so that the camera 120 may be aligned with area 21.

In one embodiment, the processor 110 may determine the one or more boundaries for the first map based on the height of the motion tracking device 100, wherein the height of the motion tracking device 100 may be detected by the IMU 130. The one or more boundary may include a boundary equal to the height of the motion tracking device 100, a boundary equal to the height of the motion tracking device 100 plus or minus a default value, or a boundary equal to another boundary plus or minus a default value. For example, the processor 110 may determine that the boundary 31 is equal to the height of the motion tracking device 100. For another example, the processor 110 may determine that boundary 32 is equal to boundary 31 minus 40 cm or the height of the motion tracking device 100 minus 40 cm.

The detection of the height of the motion tracking device 100 may be triggered by a user command or by a specific time duration. In one embodiment, the processor 110 may output an instruction message via the output device 150 to instruct the user to assume a specific posture (e.g., stand up) and operate the input device 140 to initial a user command. The processor 110 may detect the height of the motion tracking device 100 via the IMU 130 after receiving the user command. For example, the processor 110 may output an instruction message to instruct the user to stand up and operate the input device 140 to initial a user command. The processor 110 may detect the height of the motion tracking device 100 after receiving the user command, and the processor 110 may determine the boundary 31 (or 32) according to the height of the motion tracking device 100.

In one embodiment, the processor 110 may output an instruction message via the output device 150 to instruct the user to assume a specific posture and specify a start time point for capturing the first map. The processor 110 may detect the height of the motion tracking device 110 via the IMU 130 at the start time point. For example, the processor 110 may output an instruction message to instruct the user to stand up so that the motion tracking device 100 may be aligned with area 21. The processor 110 may detect the height of the motion tracking device 110 via the IMU 130 at the start time point, and the processor 110 may determine the boundary 31 (or 32) according to the height of the motion tracking device 100.

Referring back to FIG. 2. In step S202, the processor 110 may capture a second map via the camera 120 to establish a coverage of the second map. The second map may be, for example, a map corresponding to a lower area or a upper area. The processor 110 may determine one or more boundaries to restrict the coverage of the second map. The processor 110 may determine whether the coverage of the second map is completed according to the one or more boundaries.

Specifically, the processor 110 may capture the second map by performing SLAM algorithm to generate one or more key frames, wherein the position of each key frame may be measured by the IMU 130. For each key frame, the processor 110 may determine whether the key frame exceeds the boundary. If the key frame exceeds the boundary, the processor 110 may determine that the key frame is valid and may select the key frame. If the key frame exceeds the boundary, the processor 110 may determine that the key frame is invalid and may ignore the key frame. The processor 110 may determine whether the coverage of the second map is completely established according to the selected key frames. For example, the processor 110 may determine the coverage of the second map is completely established if the number of the selected key frames is greater than a threshold.

Take FIG. 3 as example, assume that the second map corresponds to area 22. Boundary 32 may be the upper boundary of the second map and the boundary 33 may be the lower boundary of the second map. The coverage of the first map and the coverage of the second map may be separated by boundary 32. The processor 110 may perform SLAM algorithm to establish the coverage of the second map by scanning the area 22 via the camera 120. If a key frame captured by the camera 120 is beyond or equal to boundary 33 and/or below or equal to boundary 32, the processor 110 may determine that the key frame is valid and may determine whether the coverage of the second map is completely established according to the valid key frame. Otherwise, if a key frame captured by the camera 120 is below boundary 33 or beyond boundary 32, the processor 110 may determine that the key frame is invalid. The completeness of the coverage of the second map will not be affected by invalid key frames.

In one embodiment, the processor 110 may detect the height of the motion tracking device 100 via the IMU 130 and determine whether the height exceeds the boundary while the second map is being captured. If the height of the motion tracking device 100 exceeds the boundary while the second map is being captured, the processor 110 may output an alarm message via the output device 150. For example, the processor 110 may output an instruction message to the user to instruct the user to assume a specific posture (e.g., squat down) for scanning the second map corresponding to area 22. The instruction message may specify a start time point and the processor 110 may start capturing the second map via the camera 120 at the start time point. Alternatively, the processor 110 may start capturing the second map via the camera 120 after receiving a user command via the input device 140. If the height of the motion tracking device 100 rises beyond boundary 32 (or falls below boundary 33) while the coverage of the second map is being scanned in area 21, the processor 110 may output the alarm message to the user to instruct the user to change his posture so that the camera 120 may be aligned with area 22.

In one embodiment, the processor 110 may determine the one or more boundaries for the second map based on the height of the motion tracking device 100, wherein the height of the motion tracking device 100 may be detected by the IMU 130. The one or more boundary may include a boundary equal to the height of the motion tracking device 100, a boundary equal to the height of the motion tracking device 100 plus or minus a default value, or a boundary equal to another boundary plus or minus a default value. For example, the processor 110 may determine that boundary 33 is equal to boundary 32 minus 40 cm. For another example, the processor 110 may instruct the user to put the motion tracking device 100 on the ground and operate the input device 140 to initial a user command. The processor 110 may detect the height of the motion tracking device 100 after receiving the user command and determine that boundary 33 is equal to the detected height.

The detection of the height of the motion tracking device 100 may be triggered by a user command or by a specific time duration. In one embodiment, the processor 110 may output an instruction message via the output device 150 to instruct the user to assume a specific posture (e.g., squat down) and operate the input device 140 to initial a user command. The processor 110 may detect the height of the motion tracking device 100 via the IMU 130 after receiving the user command. For example, the processor 110 may output an instruction message to instruct the user to squat down (or put the motion tracking device 100 on the ground) and operate the input device 140 to initial a user command. The processor 110 may detect the height of the motion tracking device 100 after receiving the user command, and the processor 110 may determine the boundary 33 (or 32) according to the height of the motion tracking device 100.

In one embodiment, the processor 110 may output an instruction message via the output device 150 to instruct the user to assume a specific posture and specify a start time point for capturing the first map. The processor 110 may detect the height of the motion tracking device 110 via the IMU 130 at the start time point. For example, the processor 110 may output an instruction message to instruct the user to squat down so that the motion tracking device 100 may be aligned with area 22. The processor 110 may detect the height of the motion tracking device 110 via the IMU 130 at the start time point, and the processor 110 may determine the boundary 33 (or 32) according to the height of the motion tracking device 100.

After the coverage of the first map and the coverage of the second map are completely established, in step S203, the processor 110 may perform motion tracking according to the first map or the second map. It should be noted that, although the embodiment of FIG. 2 merely establishes two maps for motion tracking, the number of the established maps is not limited thereto. For example, the motion tracking device 100 may establish more than two maps for performing motion tracking.

FIG. 4 illustrates a flowchart of map scanning according to one embodiment of the present invention, wherein the flowchart can be implemented by the motion tracking device 100 as shown in FIG. 1. In step S401, a user may trigger a map scanning event. For example, the user may input a user command to the motion tracking device 100 via the input device 140.

In step S402, the motion tracking device 100 may instruct the user to stand up and input a user command to create a boundary separating the upper area and the lower area. In addition, the motion tracking device 100 may instruct the user to put the motion tracking device 100 on the ground and input a user command again to create a lower boundary for the lower area.

In step S403, the motion tracking device 100 may instruct the user to squat down, and the motion tracking device 100 may start scanning a map corresponding to the lower area. The motion tracking device 100 may output an alarm message if the height of the motion tracking device 100 is beyond the boundary of the lower area while the map corresponding to the lower area is being scanned.

After the map corresponding to the lower area is completely scanned, in step S404, the motion tracking device 100 may instruct the user to stand up, and the motion tracking device 100 may start scanning a map corresponding to the upper area. The motion tracking device 100 may output an alarm message if the height of the motion tracking device 100 is beyond the boundary of the higher area while the map corresponding to the higher area is being scanned.

After the map corresponding to the higher area is completely scanned, in step S405, the motion tracking device 100 may show the result of the map quality via the output device 150. The user may decide whether to continue scanning the map. For example, the output device 150 may show that the completeness of the map scanning has reached to 90%. The user may then input a user command via the input device 140. The motion tracking device 100 may continue performing scanning the map to improve the map quality or stop based on the user command.

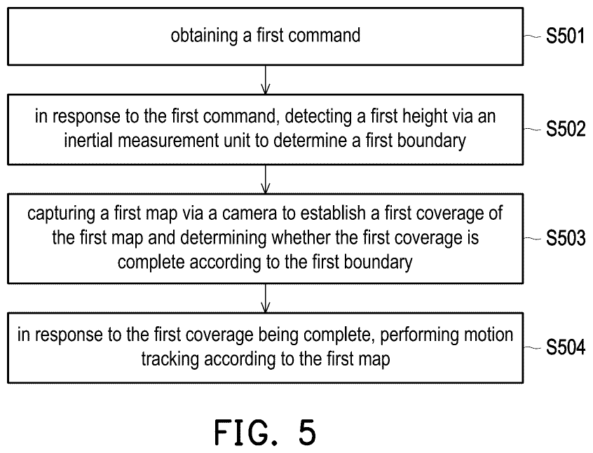

FIG. 5 illustrates a flowchart of a method of motion tracking according to one embodiment of the present invention, wherein the method can be implemented by the motion tracking device 100 as shown in FIG. 1. In step S501, obtaining a first command. In step S502, in response to the first command, detecting a first height via an inertial measurement unit to determine a first boundary. In step S503, capturing a first map via a camera to establish a first coverage of the first map and determining whether the first coverage is complete according to the first boundary. In step S504, in response to the first coverage being complete, performing motion tracking according to the first map.

In summary, the disclosed motion tracking device may establish multiple maps for for capturing the motion of a target. The motion tracking device may determine one or more boundaries to restrict the coverage of the map to be scanned, thereby reducing the number of the key frames to be processed and preventing delays in map generation. The scanning of the map can be triggered by a user command or can be initiated automatically by the motion tracking device. The motion tracking device may instruct the user wearing the device to stand up or squat down to scan different areas (e.g., upper area or lower area). During the procedure of establish the map, if the map cannot be scanned properly due to an incorrect user posture, the motion tracking device may notify the user through an alarm message.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A motion tracking device, comprising:
a camera;
an inertial measurement unit;
an input device; and
a processor, coupled to the camera, the inertial measurement unit, and the input device, wherein the processor is configured to:
obtain a first command via the input device;
in response to the first command, detect a first height via the inertial measurement unit to determine a first boundary;
capture a first map via the camera to establish a first coverage of the first map and determine whether the first coverage is complete according to the first boundary; and
in response to the first coverage being complete, perform motion tracking according to the first map.

2. The motion tracking device according to claim 1, wherein the processor is further configured to:
capture a second map via the camera, wherein a second coverage of the second map is different from the first coverage; and
performing the motion tracking according to the first map and the second map.

3. The motion tracking device according to claim 2, wherein the processor is further configured to:
determining a second boundary based on the first boundary, wherein the first coverage and the second coverage are separated by the second boundary.

4. The motion tracking device according to claim 3, further comprising:
an output device, coupled to the processor, wherein the processor is further configured to:
detect a second height via the inertial measurement unit and determine whether the second height exceeds the second boundary while the first map is being captured; and
in response to the second height exceeding the second boundary while the first map is being captured, output an alarm message via the output device.

5. The motion tracking device according to claim 2, wherein the processor is further configured to:
obtain a second command via the input device;
in response to the second command, detect a third height via the inertial measurement unit to determine a third boundary; and
determine whether the second coverage is complete according to the third boundary.

6. The motion tracking device according to claim 1, wherein the processor is further configured to:
obtain a third command via the input device; and
in response to the third command, capture the first map via the camera.

7. The motion tracking device according to claim 1, further comprising:
an output device, coupled to the processor, wherein the processor is further configured to:
output an instruction message via the output device; and
in response to outputting the instruction message, capture the first map via the camera.

8. The motion tracking device according to claim 1, wherein the first coverage is restricted by the first boundary.

9. The motion tracking device according to claim 8, wherein the processor is further configured to:
perform simultaneous localization and mapping to generate a key frame;
determine whether a position of the key frame exceeds the first boundary;
in response to the key frame not exceeding the first boundary, select the key frame; and
determine whether the first coverage is complete according to the selected key frame.

10. The motion tracking device according to claim 1, wherein the motion tracking device comprises a wearable electronic device.

11. A method of motion tracking, comprising:
obtaining a first command;
in response to the first command, detecting a first height via an inertial measurement unit to determine a first boundary;
capturing a first map via a camera to establish a first coverage of the first map and determining whether the first coverage is complete according to the first boundary; and
in response to the first coverage being complete, performing motion tracking according to the first map.

12. The method according to claim 11, wherein the step of performing the motion tracking according to the first map comprising:
capturing a second map via the camera, wherein a second coverage of the second map is different from the first coverage; and
performing the motion tracking according to the first map and the second map.

13. The method according to claim 12, further comprising:
determining a second boundary based on the first boundary, wherein the first coverage and the second coverage are separated by the second boundary.

14. The method according to claim 13, further comprising:
detecting a second height via the inertial measurement unit and determining whether the second height exceeds the second boundary while the first map is being captured; and
in response to the second height exceeding the second boundary while the first map is been captured, outputting an alarm message.

15. The method according to claim 12, further comprising:
obtaining a second command;
in response to the second command, detecting a third height via the inertial measurement unit to determine a third boundary; and
determining whether the second coverage is complete according to the third boundary.

16. The method according to claim 11, wherein the step of capturing the first map via the camera comprising:
obtain a third command; and
in response to the third command, capturing the first map via the camera.

17. The method according to claim 11, wherein the step of capturing the first map via the camera comprising:
output an instruction message; and
in response to outputting the instruction message, capturing the first map via the camera.

18. The method according to claim 11, wherein the first coverage is restricted by the first boundary.

19. The method according to claim 18, wherein the step of determining whether the first coverage is complete according to the first boundary comprising:
performing simultaneous localization and mapping to generate a key frame;
determining whether a position of the key frame exceeds the first boundary;
in response to the key frame not exceeding the first boundary, selecting the key frame; and
determining whether the first coverage is complete according to the selected key frame.
